(19) United States
(12) Patent Application Publication
(10) Pub. No.: US 2011/0122041 A1
(43) Pub. Date: May 26, 2011

(54) PLANAR ANTENNA

(75) Inventors: Ken Morishita, Tokyo (JP); Naoki Kobayashi, Tokyo (JP)

(73) Assignee: NEC CORPORATION, Tokyo (JP)

(21) Appl. No.: 13/055,856

(22) PCT Filed: Jul. 17, 2009
(86) PCT No.: PCT/JP2009/062969

§ 371 Date: Jan. 25, 2011

(30) Foreign Application Priority Data
Jul. 30, 2008 (JP) 2008-195660

(51) Int. Cl. H01Q 1/38; H01Q 1/48

(52) U.S. Cl. 343/846; 343/700 MS

(57) ABSTRACT

The present device is equipped with a first dielectric layer (1) and a second dielectric layer (2), and an antenna conductor (4), a ground conductor (5), and pad conductors (6), which are provided so as to sandwich the first dielectric layer (1) and the second dielectric layer (2) in the lamination direction respectively. The first dielectric layer (1) is arranged between the antenna conductor (4) and the ground conductor (5). The second dielectric layer (2) is arranged between either the antenna conductor (4) or the ground conductor (5), and pad conductors (6). A connection conductor (7) for electrically connecting either the antenna conductor (4) or the ground conductor (5), whichever remains, and the pad conductors (6) is provided.

### TECHNICAL FIELD

The present invention relates to a planar antenna used for a radio communication device or the like.

### BACKGROUND ART

Radio communication using microwaves or millimeter waves is becoming widespread to carry out high-speed and large-volume data communication. Electronic devices carrying out radio communication are required to reduce the size and weight of the devices themselves and realize high density mounting for mounting a plurality of electronic devices. For this reason, the radio communication devices are also required to reduce the size of antennas, which are essential for the transmission/reception of radio waves.

Planar antennas having a patch antenna structure in which a ground conductor and a square (or rectangular) or circular antenna conductor are formed on a dielectric substrate are widely used as antennas for radio communication devices. In such a planar antenna having a patch antenna structure, its resonance frequency is determined by the size of the antenna conductor and the dielectric constant of the dielectric substrate. Generally, as the frequency band that is used lowers, the size of the antenna conductor increases and the mounting area required increases. To reduce the size of an antenna, the resonance frequency may be lowered without changing the size of the antenna conductor.

With regard to the size reduction of a planar antenna, FIG. 1 of Patent Document 1 proposes a built-in antenna intended for size reduction, high performance and high degree of integration or the like. The built-in antenna is provided with micro strip antenna 1 with antenna pattern 12 formed on printed circuit board 11 and dielectric substrate 2 disposed on the surface of micro strip antenna 1. Furthermore, FIG. 1 of Patent Document 2 proposes a planar antenna apparatus intended to lower the resonance frequency and reduce the size of the antenna. The planar antenna apparatus is provided with capacitor electrode section 8 that extends at a substantially right angle from the outer edge of radiation conductor layer 7 that functions as an antenna, ground conductor layer 10 facing radiation conductor layer 7 at a predetermined distance therefrom, and metal case 2 that has upper opening 2a and that is electrically connected to ground conductor layer 10 for allowing radiation conductor layer 7 to be exposed to the outside. In the planar antenna apparatus, side wall 2b of metal case 2 that electrically operates as a ground is arranged outside capacitor electrode section 8 so as to be opposed thereto, and side wall 2b and capacitor electrode section 8 are capacitatively coupled.

As an art related to the present invention, FIG. 1 or the like of Patent Document 3 proposes an antenna apparatus intended to realize a wider-band and a more compact antenna apparatus. The antenna apparatus is provided with antenna mounting pad 18 at a position away from the edge of ground pattern 14 on insulating substrate 12 and mounted with chip antenna 16 so as to extend over pad 18 and ground pattern 14 with its power supply terminal side oriented toward ground pattern 14. Furthermore, FIG. 2 of Patent Document 4 proposes chip antenna 10 intended to realize a wider-band and a more compact chip antenna. Chip antenna 10 is provided with rectangular parallelepiped substrate 11 having mounting surface 111 and power supply electrode 12 and ground electrode 13 are provided on the surface of substrate 11.

### CITATION LIST

### Patent Document

Patent Document 1: JP2003-179427A
Patent Document 2: JP2007-13857A
Patent Document 3: JP2002-314317A
Patent Document 4: JP11-177334A

### SUMMARY OF INVENTION

### Technical Problem

The configuration described in aforementioned Patent Document 1 requires the second dielectric substrate in addition to the printed circuit board (dielectric substrate) in which the micro strip antenna is formed. A step of bonding two dielectric substrates formed separately to fix the second dielectric substrate to the micro strip antenna. Furthermore, the configuration described in Patent Document 1 lowers the resonance frequency through the effect of shortening the wavelength of an electric field in the aforementioned second dielectric substrate. In general, in a patch antenna structure, an antenna conductor and a ground conductor formed on a dielectric substrate are electromagnetically strongly bonded together so that the electric field is not easily concentrated on the second dielectric substrate. For this reason, to effectively lower the resonance frequency, the second dielectric substrate needs to be formed so that the dielectric constant thereof becomes several times to several tens of times bigger than that of the first dielectric substrate and so as to have such that the degree of thickness of the second dielectric substrate does not negate electrical conductivity, which complicates the formation of the second dielectric substrate.

Furthermore, in the configuration according to Patent Document 2, the capacitor electrode section and the metal case need to be arranged to closely face each other so that the capacitor electrode section formed to extend from the radiation conductor layer and the metal case are electromagnetically coupled. However, when a planar antenna is formed in part of the printed circuit board together with another electronic circuit, many electronic parts are also mounted around the planar antenna and it is therefore difficult to move the metal case closer to the printed circuit board. Furthermore, there is also a structure-related problem in which time and effort are required to manufacture the structure in which the capacitor electrode section is extended from the radiation conductor layer on the printed circuit board up to a position close to the metal case. Furthermore, there is also a problem in which electronic devices that do not adopt a metal case cannot realize such a technique.

It is an object of the present invention to solve the aforementioned problems and provide a planar antenna capable of lowering the resonance frequency of an antenna conductor without using any special material or structure while realizing a size reduction and a high degree of integration.

### Solution to Problem

In order to attain the above described object, a planar antenna according to a first aspect of the present invention is equipped with a first dielectric layer and a second dielectric layer, an antenna conductor, a ground conductor and a pad conductor, which are provided so as to sandwich the first dielectric layer and the second dielectric layer in the lamination direction respectively. The first dielectric layer is arranged between the antenna conductor and the ground conductor. The second dielectric layer is arranged between either the antenna conductor or the ground conductor, and the pad conductor. Furthermore, the planar antenna is equipped with a connection conductor that electrically connects either the antenna conductor or the ground conductor, whichever remains, and the pad conductor.

A planar antenna according to a second aspect of the present invention is equipped with a first dielectric layer, a second dielectric layer and a third dielectric layer, and an antenna conductor, a ground conductor, a first pad conductor and a second pad conductor provided so as to sandwich the first dielectric layer, second dielectric layer and third dielectric layer in the lamination direction respectively. The first dielectric layer is arranged between the antenna conductor and the ground conductor. The second dielectric layer is arranged between either the antenna conductor or the ground conductor, and the pad conductor. The third dielectric layer is arranged between either the antenna conductor or the ground conductor, whichever remains, and the pad conductor. Furthermore, the planar antenna is equipped with a first connection conductor that electrically connects the remaining antenna conductor or the remaining ground conductor, and the pad conductor, and a second connection conductor that electrically connects either antenna conductor or the ground conductor, which was selected as regards the second dielectric layer, and the second pad conductor.

### Advantageous Effects of Invention

The planar antenna according to the first aspect of the present invention adds a capacitance between the antenna conductor and the ground conductor, and can thereby reduce the resonance frequency of the antenna conductor and as a result, can reduce the size of the planar antenna.

The planar antenna according to the second aspect of the present invention adds two capacitances (first capacitance and second capacitance) between the antenna conductor and the ground conductor as in the case of the invention according to the first aspect, and can thereby reduce the resonance frequency of the antenna conductor and as a result, can reduce the size of the planar antenna.

Furthermore, the planar antenna according to the present invention provides a non-conductive section in the antenna conductor or ground conductor and provides a simple connection structure for electrically connecting the ground conductor or antenna conductor to the pad conductor, and thereby allows the connection conductor to electrically connect the ground conductor or antenna conductor to the pad conductor via the non-conductive section and can reduce the cost of manufacturing the planar antenna.

### BRIEF DESCRIPTION OF DRAWINGS

FIG. 1A is an exploded perspective view illustrating a planar antenna of a first exemplary embodiment.

FIG. 1B is a perspective view illustrating a connection mode using a connection conductor in the planar antenna of the first exemplary embodiment.

FIG. 2A is an exploded perspective view illustrating another configuration of the planar antenna of the first exemplary embodiment.

FIG. 2B is a perspective view illustrating the connection mode using a connection conductor in the other configuration of the planar antenna of the first exemplary embodiment.

FIG. 3A is a diagram illustrating a configuration of a patch antenna.

FIG. 3B is a schematic diagram illustrating a voltage distribution in TE10 mode.

FIG. 3C is a schematic diagram illustrating a voltage distribution in TE20 mode.

FIG. 4A is an exploded perspective view illustrating a further configuration of the planar antenna of the first exemplary embodiment.

FIG. 4B is a perspective view illustrating a connection mode using a connection conductor in a further configuration of the planar antenna of the first exemplary embodiment.

FIG. 5A is an exploded perspective view illustrating a still further configuration of the planar antenna of the first exemplary embodiment.

FIG. 5B is a perspective view illustrating a connection mode using a connection conductor in a still further configuration of the planar antenna of the first exemplary embodiment.

FIG. 6A is an exploded perspective view illustrating a planar antenna according to a second exemplary embodiment.

FIG. 6B is a perspective view illustrating a connection mode using a connection conductor in the planar antenna of the second exemplary embodiment.

FIG. 7 is an exploded perspective view illustrating a planar antenna having a patch antenna structure in which an antenna conductor and a ground conductor are formed on a dielectric substrate.

FIG. 8 is an exploded perspective view illustrating an electromagnetic field simulation model of the planar antenna according to the present invention.

FIG. 9A is a plan view illustrating an arrangement pattern including a total of 6 pad conductors.

FIG. 9B is a plan view illustrating an arrangement pattern including a total of 10 pad conductors.

FIG. 9C is a plan view illustrating an arrangement pattern including a total of 14 pad conductors.

FIG. 10 is a diagram illustrating a simulation result of a power reflection coefficient when the number of pad conductors is changed.

FIG. 11 is a diagram illustrating a simulation result of the power reflection coefficient when the size of the pad conductor is changed.

FIG. 12 is a diagram illustrating a simulation result of the power reflection coefficient when the thickness of the dielectric layer arranged between the pad conductor and the antenna conductor is changed.

FIG. 13 is a diagram illustrating a simulation result of the power reflection coefficient when the thickness of the dielectric layer arranged between the pad conductor and the antenna conductor is assumed to be 1.6 mm

FIG. 14 is a diagram illustrating a simulation result of the power reflection coefficient when the thickness of the dielectric layer arranged between the pad conductor and the antenna conductor is assumed to be 1.2 mm

FIG. 15 is a diagram illustrating a simulation result of the power reflection coefficient when the thickness of the dielectric layer arranged between the pad conductor and the antenna conductor is assumed to be 0.8 mm

### DESCRIPTION OF EMBODIMENTS

The planar antennas according to exemplary embodiments will be described with reference to the attached drawings.

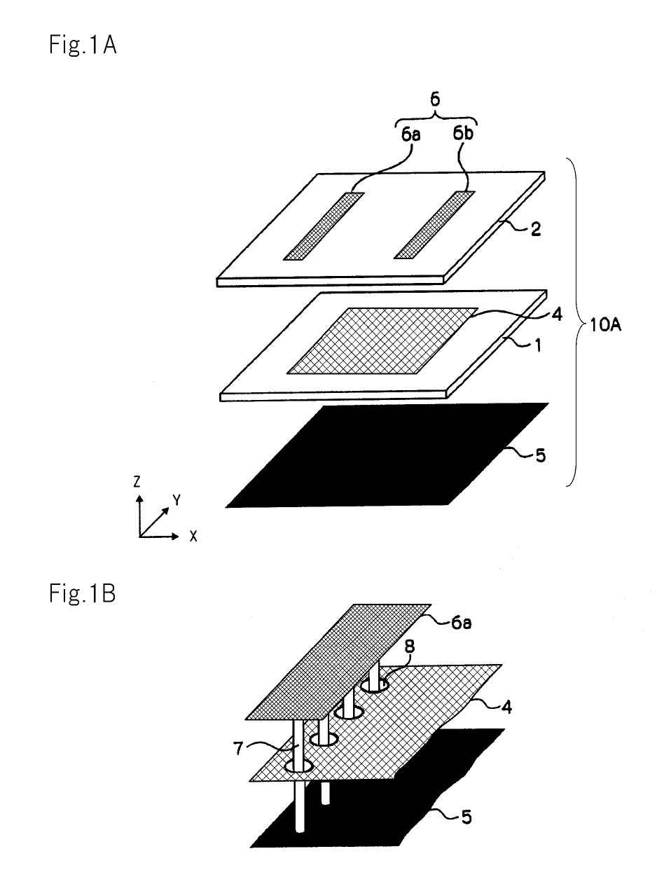

The planar antenna according to the present invention includes planar antennas 10A, 10B, 10C and 10D (planar antennas according to a first exemplary embodiment, hereinafter referred to as “planar antennas of the first exemplary embodiment”; see FIGS. 1, 2, 4 and 5) equipped with first dielectric layer 1 and second dielectric layer 2, and antenna conductor 4, ground conductor 5 and pad conductor 6 provided so as to sandwich first dielectric layer 1 and second dielectric layer 2 in the lamination direction respectively.

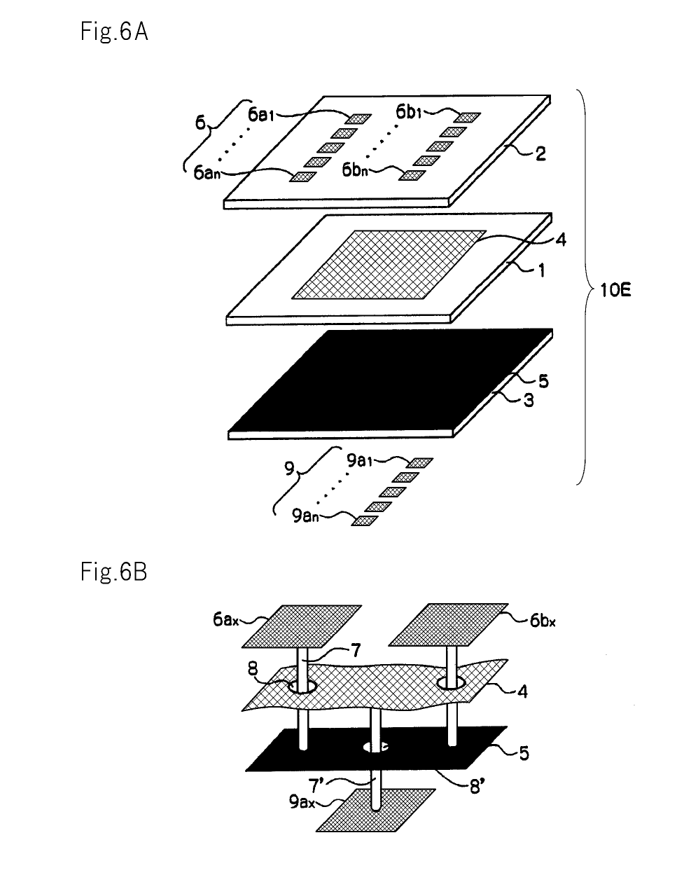

Furthermore, the planar antenna according to the present invention includes a planar antenna 10E (planar antenna according to a second exemplary embodiment, hereinafter referred to as “planar antenna of the second exemplary embodiment”; see FIG. 6) equipped with first dielectric layer 1, second dielectric layer 2 and third dielectric layer 3, and antenna conductor 4, ground conductor 5, first pad conductor 6 and second pad conductor 9 provided so as to sandwich first dielectric layer 1, second dielectric layer 2 and third dielectric layer 3 in the lamination direction respectively.

### First Exemplary Embodiment

FIGS. 1A and 1B, FIGS. 2A and 2B, FIGS. 4A and 4B and FIGS. 5A and 5B are schematic configuration diagrams illustrating examples of the planar antenna of the first exemplary embodiment. FIGS. 1A, 2A, 4A and 5A are exploded perspective views and FIGS. 1B, 2B, 4B and 5B are perspective views of connection modes using a connection conductor.

As shown in FIGS. 1A, 2A, 4A and 5A, the planar antenna of the first exemplary embodiment is configured in such a way that antenna conductor 4 and ground conductor 5 are arranged so as to face each other across first dielectric layer 1, “either antenna conductor 4 or ground conductor 5” and pad conductor 6 are arranged so as to face each other across second dielectric layer 2 and “either antenna conductor 4 or ground conductor 5, whichever remains,” are electrically connected via connection conductor 7.

Here, “either antenna conductor 4 or ground conductor 5” refers to either antenna conductor 4 or ground conductor 5 and “the remaining antenna conductor 4 or the remaining ground conductor 5” refers to the conductor that was not selected. When, for example, “either antenna conductor 4 or ground conductor 5” is antenna conductor 4, “either antenna conductor 4 or ground conductor 5, whichever remains,” is ground conductor 5, and on the contrary, when “either antenna conductor 4 or ground conductor 5” is ground conductor 5, “either antenna conductor 4 or ground conductor 5, whichever remains,” is antenna conductor 4.

According to such a planar antenna of the first exemplary embodiment, at a position at which a voltage produced between antenna conductor 4 and ground conductor 5 facing each other across first dielectric layer 1 becomes maximum, a capacitance (second dielectric layer 2) is arranged between antenna conductor 4 and pad conductor 6, and further “either antenna conductor 4 or ground conductor 5, whichever remains” and pad conductor 6 are electrically connected via connection conductor 7, and therefore the above described capacitance is added between antenna conductor 4 and ground conductor 5. The capacitance acts on the voltage between antenna conductor 4 and ground conductor 5. For this reason, by electrically connecting the pad conductor to “either antenna conductor 4 or ground conductor 5, whichever remains,” it is possible to effectively reduce the resonance frequency and reduce the size of the planar antenna.

Hereinafter, the planar antennas shown in FIGS. 1A, 1B, 2A, 2B, 4A, 4B, 5A and 5B will be described more specifically.

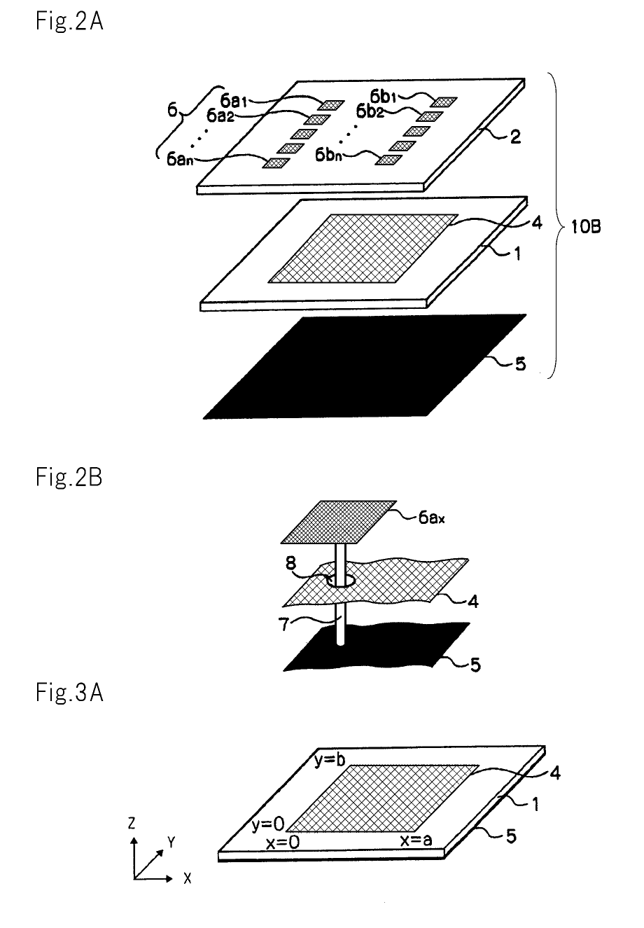

FIGS. 1A and 1B are schematic configuration diagrams illustrating an example of the planar antenna 10A of the first exemplary embodiment. FIGS. 2A and 2B are schematic configuration diagrams illustrating another example of the planar antenna 10B of the first exemplary embodiment. FIGS. 1A and 2A are exploded perspective views and FIGS. 1B and 2B are perspective views illustrating a state of electric connection between pad conductor 6 and ground conductor 5. Planar antennas 10A and 10B shown in FIG. 1A and FIG. 2A are made up of ground conductor 5, first dielectric layer 1, antenna conductor 4, second dielectric layer 2 and pad conductor 6 laminated and arranged in that order from the bottom to the top in the figure.

In other words, first dielectric layer 1 is arranged between antenna conductor 4 and ground conductor 5 and second dielectric layer 2 is arranged between antenna conductor 4 and pad conductor 6. Ground conductor 5 and pad conductor 6 are electrically connected via connection conductor 7. In still other words, ground conductor 5 and antenna conductor 4 are arranged on both sides of first dielectric layer 1, antenna conductor 4 and pad conductor 6 are arranged on both sides of second dielectric layer 2 and ground conductor 5 and pad conductor 6 are electrically connected via connection conductor 7.

Examples of the materials of antenna conductor 4, ground conductor 5 and pad conductor 6 include those generally used as conductor materials for planar antennas such as copper and aluminum. Furthermore, examples of materials of first dielectric layer 1 and second dielectric layer 2 include resin-based materials used for printed circuit boards and ceramics-based materials used for dielectric substrates. Furthermore, the sizes, shapes, thicknesses or the like of respective conductors 4, 5, 6 and dielectric layers 1 and 2 may be considered so as to allow a desired resonance frequency to be obtained, and are not particularly limited, and can be set to various sizes, shapes, thicknesses or the like.

In the example shown in FIG. 1A, antenna conductor 4 is formed into a square shape (or rectangular shape) and formed to be smaller than ground conductor 5. Pad conductor 6 is arranged on both sides in the X-axis direction of antenna conductor 4 and formed to a predetermined width so as to extend in the Y-axis direction. In the configuration example shown in FIG. 1A, pad conductor 6 is shaped like a strip rectilinearly extending in the Y-axis direction, while in the configuration example shown in FIG. 2A, pad conductor 6 is divided into a plurality of squares, arrayed in the Y-axis direction.

The shape or the like of connection conductor 7 is not particularly limited as long as it has a structure of electrically connecting ground conductor 5 and pad conductor 6, but connection conductor 7 may be preferably formed into, for example, a columnar conductor as shown in FIG. 1A and FIG. 2B. Examples of the material of connection conductor 7 include a conductive material such as copper or aluminum. Such connection conductor 7 preferably adopts a so-called “via” mode of electrically connecting between wiring layers inside a multilayered wiring substrate via a through hole. Such a via may be formed, for example, by forming a through hole in first dielectric layer 1 or second dielectric layer 2 using plating means (electroless plating, electrolytic plating or the like) and filling the through hole.

Connection conductor 7 penetrates antenna conductor 4 in the lamination direction to electrically connect ground conductor 5 and pad conductor 6 as shown in FIG. 1B and FIG. 2B. Thus, antenna conductor 4 is preferably provided with non-conductive section 8 (also referred to as “clearance hole”) to prevent contact with connection conductor 7 and has a structure in which connection conductor 7 passes through non-conductive section 8. When the via (connection conductor 7) is formed after forming the aforementioned through hole, such non-conductive section 8 can be formed by removing the conductor section around the via through etching or the like to thereby form non-conductive section 8 into a shape like an electric hole (columnar shape that prevents electric current from flowing).

When, a plurality of pad conductors 6, for example, a total of two pad conductors 6, one at each end of second dielectric layer 2 as shown in FIG. 1A, are provided, a plurality of connection conductors 7 are preferably arranged on respective pad conductors 6 (6a, 6b) at an arbitrary interval. Such a plurality of connection conductors 7 are electrically connected to ground conductor 5 respectively as shown in FIG. 1B. Furthermore, when a plurality of pad conductors 6 are arrayed, for example, at each end of second dielectric layer 2 as shown in FIG. 2A (a total of 2n pad conductors 6, n pad conductors at each end, are arrayed in the example shown in FIG. 2A), connection conductors 7 are provided for respective pad conductors 6 (6a1 . . . 6an, 6b1 . . . 6bn) and the plurality of connection conductors 7 are electrically connected to ground conductor 5 as shown in FIG. 2B.

Ground conductor 5 and pad conductor 6 are electrically connected in the lamination direction via non-conductive section 8 provided in antenna conductor 4. Thus, the connection distance between ground conductor 5 and pad conductor 6 is relatively short, the connection structure is simple, and moreover ground conductor 5 and pad conductor 8 can be simply connected using connection members such as through holes and vias described above. As a result, this is advantageous in providing low cost planar antennas. Here, a capacitance is added between antenna conductor 4 and ground conductor 5 by adopting such a connection structure.

Pad conductor 6 is preferably provided at a position where the voltage between antenna conductor 4 and ground conductor 5 becomes maximum at the resonance frequency of the antenna. Patch antenna 10A of the present exemplary embodiment in which square antenna conductor 4 is arranged above ground conductor 5 via first dielectric layer 1 mainly uses a basic resonance mode in which a voltage standing wave that has a half wavelength is generated between antenna conductor 4 and ground conductor 5. In this basic resonance mode, the voltage generated between antenna conductor 4 and ground conductor 5 becomes maximum in each region at both ends in which the separation distance between them is maximum and becomes minimum in the center between both ends of the region in which antenna conductor 4 is formed. That is, the voltage generated in each region at both ends where the separation distance is maximum becomes maximum, while the voltage generated in the center region between both ends becomes minimum in the region in which antenna conductor 4 is formed.

The present exemplary embodiment adds a capacitance between antenna conductor 4 and ground conductor 5 and the capacitance acts on the voltage between antenna conductor 4 and ground conductor 5. Thus, arranging pad conductor 6 at a position where the voltage between antenna conductor 4 and ground conductor 5 becomes maximum allows the resonance frequency to be effectively reduced.

The example shown in FIGS. 1A and 1B shows a configuration in the case of a basic resonance mode in which a voltage standing wave having a half wavelength is generated between antenna conductor 4 and ground conductor 5 and pad conductors 6a and 6b are provided in regions at both ends (in FIG. 1A, region where both ends of square antenna conductor 4 in the X-axis direction (left-to-right direction in the figure) extend in the Y-axis direction) in which the separation distance between them is maximum in antenna conductor 4 of the region where antenna conductor 4 is formed when planar antenna 10A is seen in a plan view. That is, when planar antenna 10A is seen in a plan view, pad conductors 6a and 6b formed to a predetermined width along both sides facing each other of square antenna conductor 4 are provided in the region where ground conductor 5 and square antenna conductor 4 overlap with each other.

On the other hand, the example shown in FIGS. 2A and 2B shows the case of a resonance mode in which a voltage standing wave having 1 wavelength is generated between antenna conductor 4 and ground conductor 5 and pad conductors (6a1 . . . 6an, 6b1 . . . 6bn) are provided in a square shape divided into regions at both ends (in FIG. 2A, regions extending in the Y-axis direction at both ends in the X-axis direction (left-to-right direction in the figure) of square antenna conductor 4) at both ends in which the separation distance between them is maximum in the region where antenna conductor 4 is formed when planar antenna 10B is seen in a plan view. That is, in the region where ground conductor 5 and square antenna conductor 4 overlap with each other when seen in the plan view, pad conductors 6a and 6b of a predetermined width are provided, distributed at predetermined intervals along both sides facing each other of square antenna conductor 4.

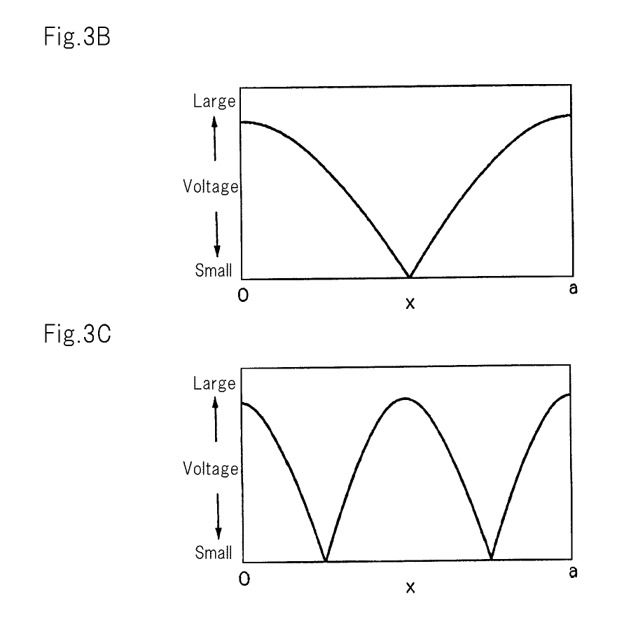

Here, the relationship between the resonance mode of antenna conductor 4 and the position where pad conductor 6 is formed will be described in detail. FIG. 3A shows a patch antenna in which ground conductor 5 is formed on one side (underside) of first dielectric substrate 1 and square antenna conductor 4 is formed on the other side (top surface). Furthermore, FIG. 3B shows a voltage distribution in TE10 mode and FIG. 3C shows a voltage distribution in TE20 mode.

The patch antenna mainly uses a basic resonance mode in which a voltage standing wave having a half wavelength is generated between antenna conductor 4 and ground conductor 5. In the configuration example shown in FIG. 3A, a voltage as shown in FIG. 3B is generated between antenna conductor 4 and ground conductor 5 in the basic resonance mode. That is, the patch antenna shown in FIG. 3A has no distribution in the Y-axis direction and produces a voltage standing wave having a half wavelength whose voltage becomes maximum at both ends in the X-axis direction and becomes minimum in the center in the X-axis direction as shown in FIG. 3B.

In the planar antenna of the present exemplary embodiment, as shown in FIGS. 1A, 1B and FIGS. 2A and 2B, the capacitance arranged between antenna conductor 4 and pad conductors 6 (6a, 6b) is added between antenna conductor 4 and ground conductor 5 through an electrical connection between pad conductor 6 and ground conductor 5 via connection conductor 7. The capacitance then acts on the voltage between antenna conductor 4 and ground conductor 5. For this reason, by arranging the pad conductor 6 at a position where the voltage generated between antenna conductor 4 and ground conductor 5 becomes maximum at the resonance frequency of the antenna, it is possible to effectively reduce the resonance frequency. FIGS. 1A, 1B and FIGS. 2A and 2B show examples of the basic resonance mode in which a voltage standing wave having a half wavelength is generated between antenna conductor 4 and ground conductor 5, and pad conductors 6a and 6b facing each other are formed at both ends in the X-axis direction of antenna conductor 4 where the voltage becomes maximum.

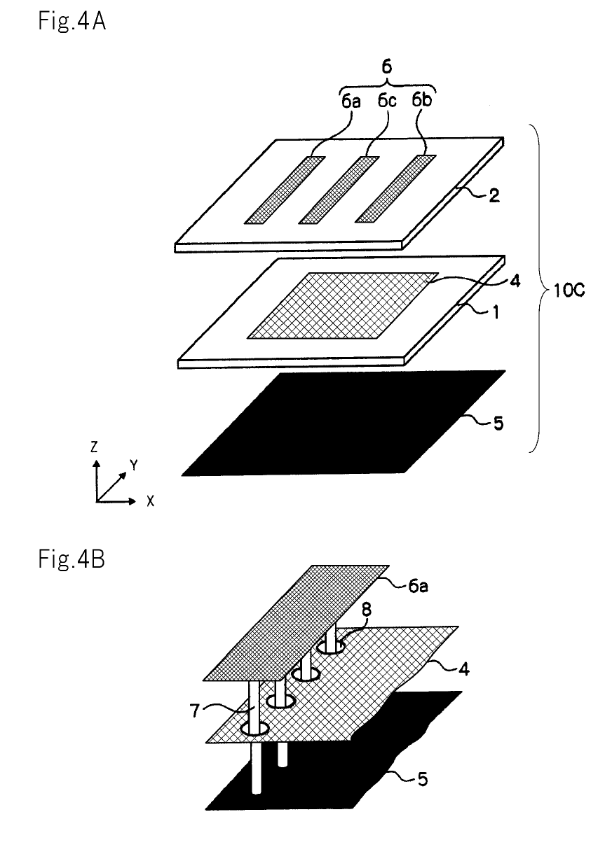

Furthermore, also when a resonance mode generated at a high frequency is used, pad conductor 6 may be formed so that a capacitance is added at a position where the voltage at the time of resonance becomes maximum in the same way as that described above. For example, as shown in FIG. 3C, in the resonance mode in which a voltage standing wave of 1 wavelength is generated between antenna conductor 4 and ground conductor 5, the positions where the voltage between antenna conductor 4 and ground conductor 5 becomes maximum are both ends and the center between both ends. Thus, as in the case of planar antenna 10C shown in FIG. 4, pad conductors 6a and 6b are provided at both ends at both ends in which the separation distance between them is maximum in the region where antenna conductor 4 is formed, and moreover, pad conductor 6c is preferably provided in the center between both ends as well, and as a result, it is possible to effectively reduce the resonance frequency. The rest of the configuration of planar antenna 10C shown in FIG. 4A is similar to those of planar antennas 10A and 10B shown in FIG. 1A and FIG. 2A, and therefore descriptions thereof will be omitted.

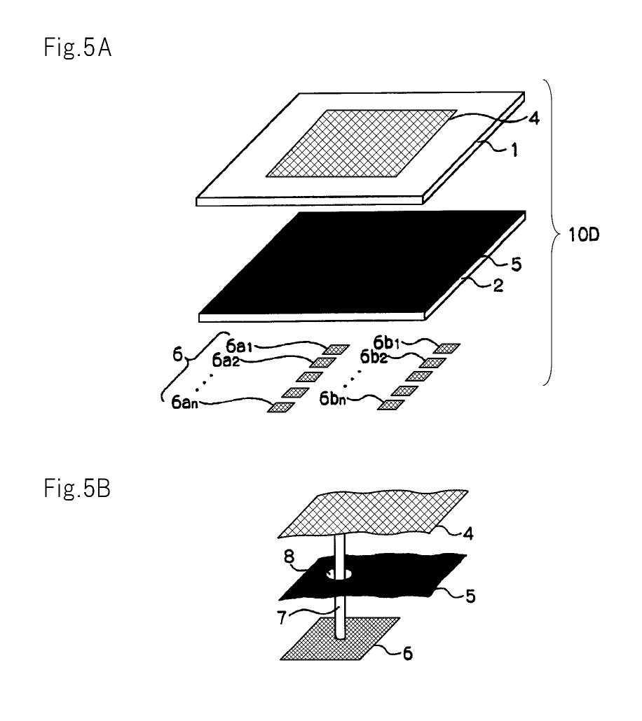

FIGS. 5A and 5B are exploded perspective views illustrating a further example of the planar antenna of the first exemplary embodiment, FIG. 5A is an exploded perspective view and FIG. 5B is a perspective view illustrating a connection mode between pad conductor 6 and antenna conductor 4. A planar antenna 10D shown in FIG. 5A is conceptually the same as planar antennas 10A, 10B and 10C shown in FIGS. 1A, 2A and 4A in that planar antenna 10D is configured in such a way that antenna conductor 4 and ground conductor 5 are arranged so as to face each other across first dielectric layer 1, “either antenna conductor 4 or ground conductor 5” and pad conductor 6 are arranged so as to face each other across second dielectric layer 2 and “either antenna conductor 4 or ground conductor 5, whichever remains,” and pad conductor 6 are electrically connected via connection conductor 7.

However, in FIG. 5A, when seen from the bottom to the top, pad conductor 6, second dielectric layer 2, ground conductor 5, first dielectric layer 1 and antenna conductor 4 are laminated and arranged in that order and a specific arrangement of the pad conductor 6 is different from the arrangements of planar antennas 10A, 10B and 10C shown in FIGS. 1A, 2A and 4A. In other words, FIG. 5A is the same as FIG. 1 or the like in that antenna conductor 4 and ground conductor 5 are arranged so as to face each other across first dielectric layer 1, but in FIG. 5A, ground conductor 5 and pad conductor 6 are arranged so as to face each other across second dielectric layer 2 and antenna conductor 4 and pad conductor 6 are electrically connected via connection conductor 7, and in this sense, antenna conductor 4 and ground conductor 5 shown in FIG. 1A or the like are switched round. In still other words, the mode in FIG. 5A is the same as the mode shown in FIG. 1A or the like in that ground conductor 5 and antenna conductor 4 are arranged on both sides of first dielectric layer 1, but in FIG. 5A, ground conductor 5 and pad conductor 6 are arranged on both sides of second dielectric layer 2 and antenna conductor 4 and pad conductor 6 are electrically connected via connection conductor 7, and in this sense, antenna conductor 4 and ground conductor 5 in FIG. 1A or the like are switched round. From a different standpoint, the configuration shown in FIG. 5A corresponds to the configuration shown in FIGS. 1A, 2A and 4A with only the positional relationship between antenna conductor 4 and ground conductor 5 inverted but the structure shown in FIG. 5A is the same as the structure shown in FIG. 1A or the like if seen upside down after switching the positions of antenna conductor 4 and ground conductor 5.

In planar antenna 10D, since connection conductor 7 that electrically connects antenna conductor 4 and pad conductor 6 is provided in such a way as to penetrate ground conductor 5, first dielectric layer 1 between antenna conductor 4 and ground conductor 5 functions as a capacitance added between antenna conductor 4 and ground conductor 5.

Since antenna conductor 4, ground conductor 5, pad conductor 6, connection conductor 7, non-conductive section 8 or the like are similar to those shown in aforementioned FIG. 1 or the like, descriptions thereof will be omitted here.

Planar antenna 10D shown in FIG. 5A also has the effect of reducing the resonance frequency through the capacitance added between antenna conductor 4 and ground conductor 5. Thus, since planar antennas 10A to 10D according to the first exemplary embodiment obtain similar effects irrespective of whether pad conductor 6 is formed so as to face antenna conductor 4 or is formed so as to face ground conductor 5, when the antenna is provided inside a printed circuit board in which another electronic circuit is formed, pad conductor 6 may be provided so as to face antenna conductor 4 or face ground conductor 5 according to the layer configuration of the printed circuit board or the configuration of a power supply circuit for the antenna, which widens the range of selection.

In the respective figures of the present invention, the power supply structure for antenna conductor 4 is omitted, but a structure such as backside power supply, coplanar power supply or electromagnetic coupling power supply may be adopted as required.

### Second Exemplary Embodiment

FIGS. 6A and 6B are schematic configuration diagrams illustrating an example of a planar antenna according to a second exemplary embodiment, FIG. 6A is an exploded perspective view, FIG. 6B is a perspective view illustrating a connection structure between the first pad conductor and the ground conductor and a connection structure between the antenna conductor and the second pad conductor. As shown in FIG. 6A, planar antenna 10E according to the second exemplary embodiment is a planar antenna provided with antenna conductor 4, ground conductor 5, first pad conductor 6 and second pad conductor 9 so as to sandwich first dielectric layer 1, second dielectric layer 2 and third dielectric layer 3 respectively. Planar antenna 10E is configured such that antenna conductor 4 and ground conductor 5 are arranged so as to face each other across first dielectric layer 1, “either antenna conductor 4 or ground conductor 5” and first pad conductor 6 are arranged so as to face each other across second dielectric layer 2. Furthermore, “either antenna conductor 4 or ground conductor 5, whichever remains,” and first pad conductor 6 are electrically connected via first connection conductor 7, “remaining antenna conductor 4 or remaining ground conductor 5” and second pad conductor 9 are arranged so as to face each other across third dielectric layer 3 and “either antenna conductor 4 or ground conductor 5” and second pad conductor 9 are electrically connected via second connection conductor 7′. In the same way as that described above, “either antenna conductor 4 or ground conductor 5” refers to either antenna conductor 4 or ground conductor 5 and “the remaining antenna conductor 4 or the remaining ground conductor 5” refers to the conductor that was not selected.

According to the planar antenna of the second exemplary embodiment as in the case of the first exemplary embodiment, at a position where the voltage between antenna conductor 4 and ground conductor 5 facing each other across first dielectric layer 1 becomes maximum, second dielectric layer 2 (which becomes a first capacitance) is arranged between “either antenna conductor 4 or ground conductor 5”, and “first pad conductor 6,” third dielectric layer 3 (which becomes a second capacitance) is arranged between “either antenna conductor 4 or ground conductor 5, whichever remains,”, and “second pad conductor 9,” and further “first pad conductor 6” is electrically connected to “remaining antenna conductor 4 or remaining ground conductor 5” via connection conductor 7 and “second pad conductor 9” is electrically connected to “either antenna conductor 4 or ground conductor 5” via connection conductor 7′. Thus, the first capacitance is added between antenna conductor 4 and ground conductor 5. On the other hand, the second capacitance is also added between antenna conductor 4 and ground conductor 5. Furthermore, since the first capacitance and second capacitance act on the voltage generated between both antenna conductor 4 and ground conductor 5, first pad conductor 6 is electrically connected to “either antenna conductor 4 or ground conductor 5, whichever remains,” second pad conductor 9 is electrically connected to “either antenna conductor 4 or ground conductor 5,” and it is thereby possible to effectively reduce the resonance frequency and realize a size reduction of the planar antenna.

To be more specific, planar antenna 10E shown in FIG. 6A is made up of second pad conductor 9, third dielectric layer 3, ground conductor 5, first dielectric layer 1, antenna conductor 4, second dielectric layer 2 and first pad conductor 6 laminated in that order from the bottom to the top in the figure.

In other words, first dielectric layer 1 is arranged between antenna conductor 4 and ground conductor 5, second dielectric layer 2 is arranged between antenna conductor 4 and first pad conductor 6 and third dielectric layer 3 is arranged between ground conductor 5 and second pad conductor 9. Ground conductor 5 and first pad conductor 6 are electrically connected via connection conductor 7, and antenna conductor 4 and second pad conductor 9 are electrically connected via connection conductor 7′.

In still other words, ground conductor 5 and antenna conductor 4 are arranged on both sides of first dielectric layer 1 respectively, antenna conductor 4 and first pad conductor 6 are arranged on both sides of second dielectric layer 2 respectively, and ground conductor 5 and second pad conductor 9 are arranged on both sides of third dielectric layer 3 respectively. Ground conductor 5 and first pad conductor 6 are electrically connected via connection conductor 7, and antenna conductor 4 and second pad conductor 9 are electrically connected via connection conductor 7′.

The components making up the planar antenna of the second exemplary embodiment are similar to those of the planar antenna of the aforementioned first exemplary embodiment and examples of materials for antenna conductor 4, ground conductor 5, first pad conductor 6 and second pad conductor 9 include copper, aluminum and other materials generally used as conductor materials for planar antennas. Furthermore, examples of materials for first dielectric layer 1, second dielectric layer 2 and third dielectric layer 3 include resin-based material used for printed circuit boards and ceramics-based material used for dielectric substrates. Furthermore, the sizes, shapes, thicknesses or the like of the respective conductors and dielectric layers may be considered so as to allow a desired resonance frequency to be obtained, and are not particularly limited, and can be set to various sizes, shapes, thicknesses or the like.

Furthermore, in the example shown in FIG. 6A, first pad conductor 6 provided on the top surface of second dielectric layer 2 is formed into a plurality of squares distributed in the Y-axis direction at both ends in the X-axis direction (see FIGS. 1A, 4A or the like) of antenna conductor 4 as in the case of pad conductor 6 in FIG. 2A. In the example shown in FIG. 6A, a total of 2n squares, n squares at each end, are provided, constituting first pad conductors 6 (6a1 . . . 6an, 6b1 . . . 6bn). As shown in FIG. 6B, individual first pad conductors 6 (6a1 . . . 6an, 6b1 . . . 6bn) are provided with their respective connection conductors 7 and the plurality of connection conductors 7 penetrate non-conductive sections 8 of antenna conductor 4 as shown in FIG. 6B and electrically connected to ground conductor 5.

On the other hand, third pad conductor 9 provided on the underside of third dielectric layer 3 is formed into a plurality of squares distributed in the Y-axis direction in the center region between both ends in the X-axis direction (see FIGS. 1A and 4A or the like) of antenna conductor 4. In the example shown in FIG. 6A, one row of n squares is provided in the center region, making up third pad conductor 9 (9a1 . . . 9an). As shown in FIG. 6B, individual third pad conductors 9 (9a1 . . . 9an) provided on the underside of third dielectric layer 3 are provided with their respective connection conductor 7′ and the plurality of connection conductors 7′ penetrate non-conductive section 8′ of ground conductor 5 and are electrically connected to antenna conductor 4 as shown in FIG. 6B.

As shown in FIG. 6A and FIG. 6B, first pad conductors 6a and 6b provided on the top surface of second dielectric layer 2 are provided at positions where the voltage between antenna conductor 4 and ground conductor 5 becomes maximum, that is, positions facing the respective regions of both ends in which the separation distance between them is maximum in region where antenna conductor 4 is formed. This position is a position at which the voltage becomes maximum irrespective of whether the mode is a basic resonance mode in which the voltage standing wave having a half wavelength is generated between antenna conductor 4 and ground conductor 5 or a resonance mode in which the voltage standing wave of 1 wavelength is generated between antenna conductor 4 and ground conductor 5. A first capacitance (second dielectric layer 2) arranged between antenna conductor 4 and first pad conductors 6 (6a, 6b) is added between antenna conductor 4 and ground conductor 5 through an electric connection between first pad conductor 6 and ground conductor 5 via connection conductor 7. The first capacitance acts on the voltage between antenna conductor 4 and ground conductor 5. Thus, by arranging first pad conductors 6 at positions where the voltage generated between antenna conductor 4 and ground conductor 5 becomes maximum at the resonance frequency of the antenna, it is possible to effectively reduce the resonance frequency.

Furthermore, second pad conductors 9 provided on the underside of third dielectric layer 3 are provided in the center region between both ends in the X-axis direction (see FIGS. 1A and 4A or the like) of antenna conductor 4, and this region is a position where the voltage becomes maximum in the same way as the voltage at both ends in the case of the resonance mode in which a voltage standing wave having 1 wavelength is generated between antenna conductor 4 and ground conductor 5. The second capacitance (third dielectric layer 3) arranged between ground conductor 5 and second pad conductor 9 is added between antenna conductor 4 and ground conductor 5 through an electric connection between antenna conductor 4 and second pad conductor 9 via connection conductor 7′ and the second capacitance acts on the voltage between antenna conductor 4 and ground conductor 5. Thus, by providing second pad conductor 9 in the center region where the voltage between antenna conductor 4 and ground conductor 5 becomes maximum in the above described resonance mode, it is possible to effectively reduce the resonance frequency.

Ground conductor 5 and first pad conductor 6 are electrically connected via connection conductor 7 that penetrates antenna conductor 4 in the lamination direction via non-conductive section 8 provided in antenna conductor 4, and further antenna conductor 4 and second pad conductor 9 are electrically connected via connection conductor 7′ that penetrates ground conductor 5 in the lamination direction via non-conductive section 8′ provided in ground conductor 5. For this reason, the present exemplary embodiment has a short connection distance, has a simple connection structure and provides a simple way of connections using connection members such as through holes and vias as in the case of the planar antenna of the first exemplary embodiment.

As a result, the present exemplary embodiment is advantageous in providing a low cost planar antenna. The connection structure of the second exemplary embodiment functions so as to add a capacitance between antenna conductor 4 and ground conductor 5. Connection conductors 7 and 7′ and non-conductive sections 8 and 8′ have configurations similar to those of the planar antenna of the aforementioned first exemplary embodiment, and therefore descriptions thereof will be omitted.

As described so far, planar antenna 10E shown in FIG. 6A adds the first capacitance and the second capacitance between antenna conductor 4 and ground conductor 5, and can thereby increase capacitance compared to the planar antenna of the first exemplary embodiment in which one capacitance is added, and can more effectively lower the resonance frequency and realize a further size reduction of the planar antenna.

As described so far, the planar antennas of the first and second exemplary embodiments of the present invention can control the reduction rate of the resonance frequency by changing the capacitance formed between the pad conductor, antenna conductor or ground conductor according to the size, shape and arrangement position of the pad conductor, thickness or dielectric constant of the dielectric layer on which the pad conductor is formed.

### EXAMPLES

Hereinafter, a simulation about a reduction of resonance frequency by the planar antenna will be performed and the present invention will be described in further detail with reference to the result.

### [Simulation]

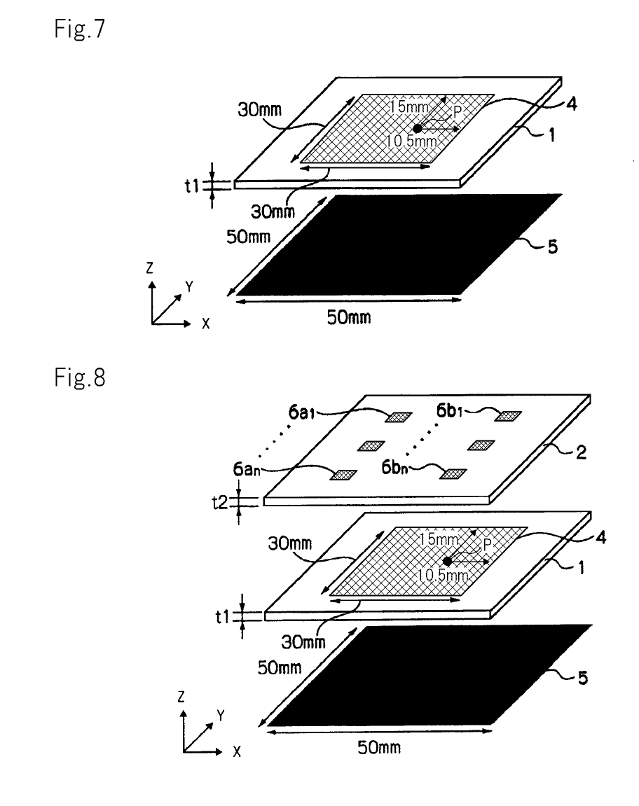

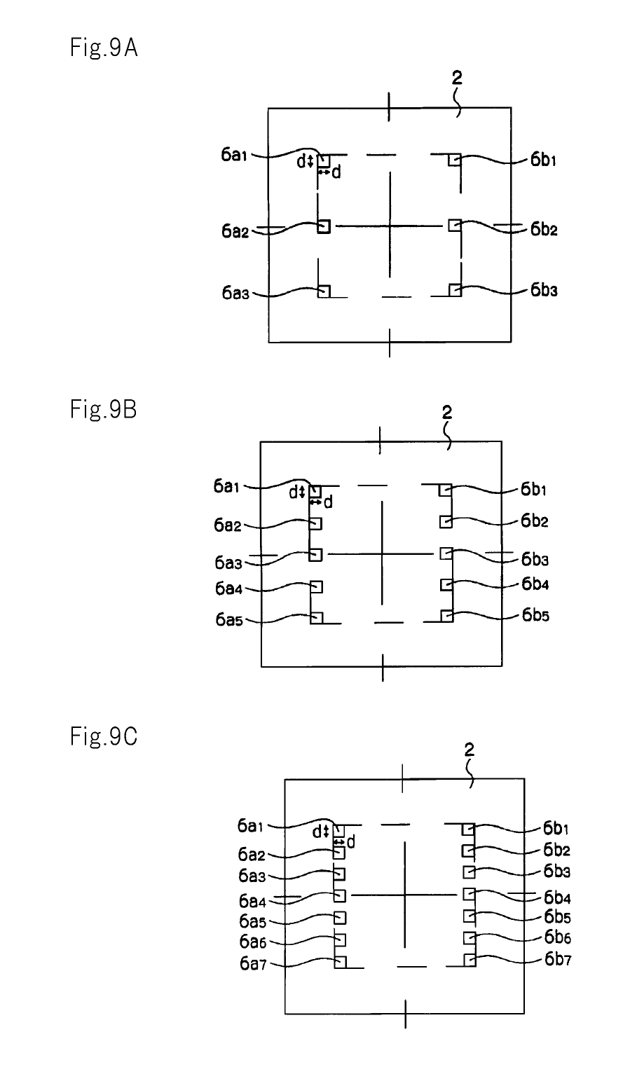

FIG. 7 is an exploded perspective view illustrating a planar antenna having a patch antenna structure in which antenna conductor 4 and ground conductor 5 are formed on a dielectric substrate (hereinafter referred to as “dielectric substrate 1”) which is first dielectric layer 1. FIG. 8 is an exploded perspective view illustrating an electromagnetic field simulation model of the planar antenna according to the present invention. FIGS. 9A, 9B and 9C are plan views illustrating arrangement patterns of pad conductor 6. FIG. 9A illustrates an example with a total of six first pad conductors (hereinafter referred to as “pattern 1”). FIG. 9B illustrates an example with a total of ten first pad conductors (hereinafter referred to as “pattern 2”). FIG. 9C illustrates an example with a total of 14 first pad conductors (hereinafter referred to as “pattern 3”).

As shown in FIG. 7, ground conductor 5 that is 50 mm×50 mm in size is formed on the bottom surface of dielectric substrate 1 formed to a size of 50 mm×50 mm and thickness t1 and antenna conductor 4 that is 30 mm×30 mm in size is formed in the center of the top surface of dielectric substrate 1. For dielectric substrate 1, suppose a fluorine resin substrate is used and the dielectric constant thereof is “2.4” and the dielectric loss tangent is “0.002.” At signal source connection position P shown in FIG. 7, a resistor of 50Ω and a voltage source are connected in series between antenna conductor 4 and ground conductor 5 to serve as a power supply section for the antenna. Here, suppose the patch antenna is used in a basic mode in which a voltage standing wave having a half wavelength is generated in the X-axis direction and signal source connection position P is provided at a center section at a position 10.5 mm from the end in the X-axis direction of antenna conductor 4 and 15 mm from the end in the Y-axis direction so as to cause the resistance of the power supply section to match the input impedance of the antenna.

FIG. 8 is an exploded perspective view illustrating the planar antenna according to the present invention. In addition to the structure shown in FIG. 7, FIG. 8 illustrates an example where second dielectric layer 2 having thickness t2 is formed on antenna conductor 4, a plurality of square pad conductors 6 having a size of (d×d) are arranged on the top surface of second dielectric layer 2 facing both ends in the X-axis direction of antenna conductor 4 where the voltage becomes maximum at the time of resonance. There are three types of arrangement of pad conductor 6 as shown in FIGS. 9A to 9C which are referred to as “patterns 1 to 3” respectively. Pad conductor 6 and ground conductor 5 are electrically connected via connection conductor 7 that penetrates antenna conductor 4 via non-conductive section 8 of antenna conductor 4 as in the case of FIG. 1B. The diameter of connection conductor 7 is 0.3 mm and the diameter of non-conductive section 8 (clearance hole) is 1.0 mm

Using the simulation models shown in FIG. 7, FIG. 8 and FIGS. 9A to 9C, a power reflection coefficient which is a ratio of input power from the signal source to reflection power was calculated. An FDTD (Finite Difference Time Domain) method which is an electromagnetic field analysis technique was used for these simulations.

### [Results]

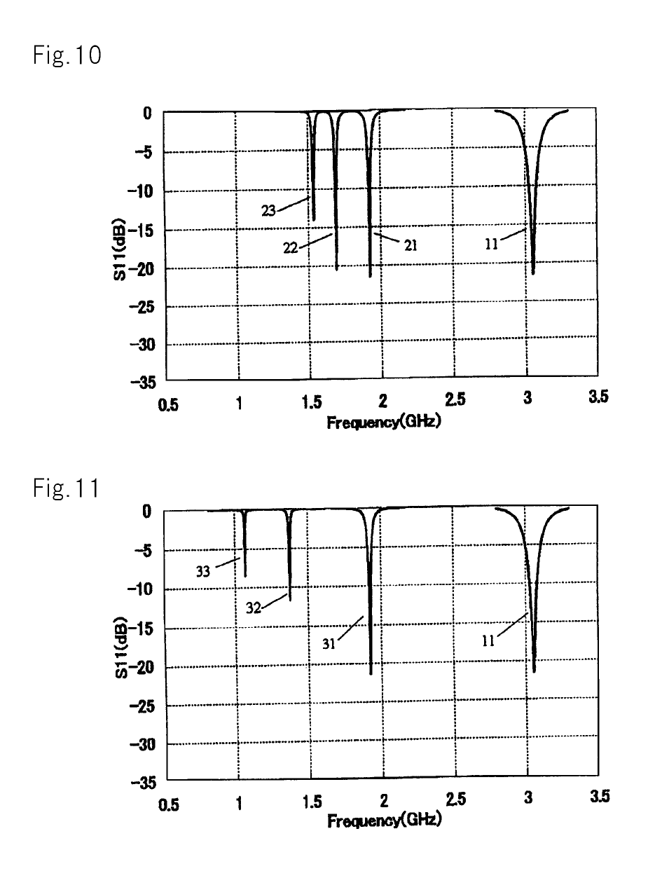

FIG. 10 shows simulation results of arrangement patterns 1 to 3 (corresponding to FIG. 9A to FIG. 9C respectively) of pad conductor 6 assuming the thickness of dielectric substrate 1 is t1=1.6 mm, the thickness of second dielectric layer 2 is t2=0.2 mm and the length of each side of pad conductor 6 is d=3 mm. In FIG. 10, waveform 11 shows a power reflection coefficient of the simulation model shown in FIG. 8 when t1=1.6 mm. Waveform 21 shows a power reflection coefficient of the simulation model shown in FIG. 9A with pattern 1, t1=1.6 mm, t2=0.2 mm and d=3 mm. Waveform 22 shows a power reflection coefficient of the simulation model shown in FIG. 9B with pattern 2, t1=1.6 mm, t2=0.2 mm and d=3 mm Waveform 23 shows a power reflection coefficient of the simulation model shown in FIG. 9C with pattern 3, t1=1.6 mm, t2=0.2 mm and d=3 mm

FIG. 11 shows simulation results when the size of pad conductor 6 is d=3 mm, 5 mm and 7 mm assuming the thickness of dielectric layer 1 is t1=1.6 mm, the thickness of second dielectric layer 2 is t2=0.2 mm and the arrangement of pad conductor 6 is pattern 1 (corresponding to FIG. 9A). In FIG. 11, waveform 11 shows a power reflection coefficient of the simulation model shown in FIG. 8 when t1=1.6 mm. Waveform 31 shows a power reflection coefficient of the simulation model shown in FIG. 9A with pattern 1, t1=1.6 mm, t2=0.2 mm and d=3 mm. Waveform 32 shows a power reflection coefficient of the simulation model shown in FIG. 9A with pattern 1, t1=1.6 mm, t2=0.2 mm and d=5 mm. Waveform 33 shows a power reflection coefficient of the simulation model shown in FIG. 9A with pattern 1, t1=1.6 mm, t2=0.2 mm and d=7 mm

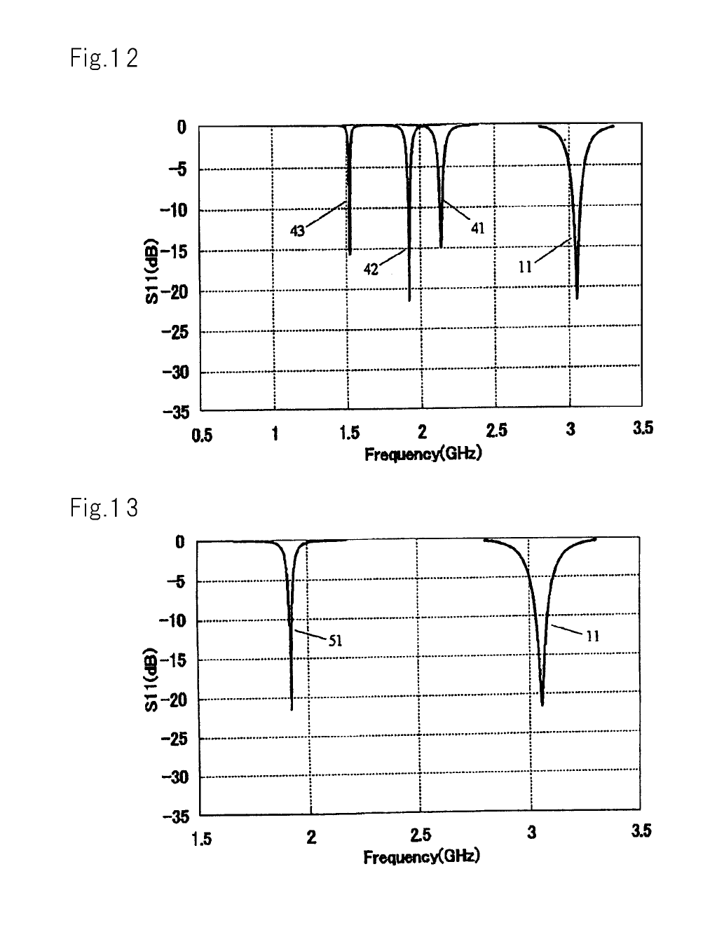

FIG. 12 shows simulation results when the thickness of second dielectric layer 2 is t2=0.1 mm, 0.2 mm and 0.3 mm assuming the thickness of dielectric substrate 1 is t1=1.6 mm, the size of pad conductor 6 is d=3 mm and the arrangement of pad conductor 6 is pattern 1. In FIG. 12, waveform 41 shows a power reflection coefficient of the simulation model shown in FIG. 9A with pattern 1, t1=1.6 mm, t2=0.3 mm and d=7 mm. Waveform 42 shows a power reflection coefficient of the simulation model shown in FIG. 9A with pattern 1, t1=1.6 mm, t2=0.2 mm and d=3 mm. Waveform 43 shows a power reflection coefficient of the simulation model shown in FIG. 9A with pattern 1, t1=1.6 mm, t2=0.1 mm and d=7 mm

FIG. 13 shows simulation results when the thickness of first dielectric layer 1 is t1=1.6 mm assuming that the thickness of second dielectric layer 2 is t2=0.2 mm, the size of pad conductor 6 is d=3 mm and the arrangement of pad conductor 6 is pattern 1. In FIG. 13, waveform 11 shows a power reflection coefficient of the simulation model shown in FIG. 8 when t1=1.6 mm. Waveform 51 shows a power reflection coefficient of the simulation model shown in FIG. 9A with pattern 1, t1=1.6 mm, t2=0.2 mm and d=3 mm

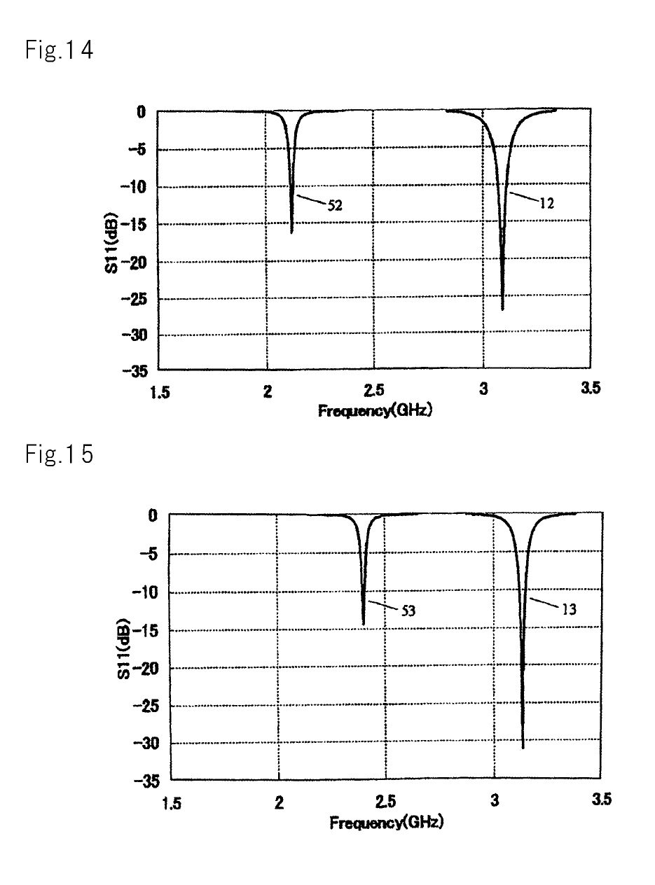

As in the case of the configuration shown in FIG. 13, the configuration shown in FIG. 14 also shows simulation results when the thickness of dielectric substrate 1 is t1=1.2 mm assuming that the thickness of second dielectric layer 2 is t2=0.2 mm, the size of pad conductor 6 is d=3 mm and the arrangement of pad conductor 6 is pattern 1. In FIG. 14, waveform 12 shows a power reflection coefficient of the simulation model shown in FIG. 8 when t1=1.2 mm. Waveform 52 shows a power reflection coefficient of the simulation model shown in FIG. 9A with pattern 1, t1=1.2 mm, t2=0.2 mm and d=3 mm.

As in the case of the configuration shown in FIG. 13, the configuration shown in FIG. 15 also shows simulation results when the thickness of dielectric substrate 1 is t=0.8 mm assuming that the thickness of second dielectric layer 2 is t2=0.2 mm, the size of pad conductor 6 is d=3 mm and the arrangement of pad conductor 6 is pattern 1. In FIG. 15, waveform 13 shows a power reflection coefficient of the simulation model shown in FIG. 8 when t1=0.8 mm. Waveform 53 shows a power reflection coefficient of the simulation model shown in FIG. 9A with pattern 1, t1=0.8 mm, t2=0.2 mm and d=3 mm

FIG. 10 to FIG. 15 only show results in the vicinity of a resonance frequency in the basic mode of the power reflection coefficients for which simulations were performed. The frequency corresponding to a minimum power reflection coefficient is a resonance frequency.

As shown in the results in FIG. 10 to FIG. 15, the resonance frequency decreases as the number of pad conductor 6 increases, as the size of pad conductor 6 increases, as second dielectric layer 2 becomes thinner, that is, as the capacitance formed between pad conductor 6 and antenna conductor 4 increases. Furthermore, as shown in the results in FIG. 13 to FIG. 15, even when the capacitance between pad conductor 6 and antenna conductor 4 is the same, the rate of decrease of the resonance frequency increases as the thickness of dielectric layer 1 between antenna conductor 4 and ground conductor 5 increases. This is because as dielectric substrate 1 between antenna conductor 4 and ground conductor 5 becomes thicker, the capacitance between antenna conductor 4 and ground conductor 5 decreases and the capacitance between pad conductor 6 and antenna conductor 4 added thereto relatively increases.

As described so far, by changing the capacitance formed between pad conductor 6 and antenna conductor 4 and the capacitance formed between antenna conductor 4 and ground conductor 5, it is possible to adjust the rate of reduction of the resonance frequency.

The present invention has been described so far with reference to the exemplary embodiments, but the present invention is not limited to the above described exemplary embodiments. Various modifications understandable to those skilled in the art can be made to the configuration and details of the present invention without departing from the scope of the present invention.

The present application claims priority based on Japanese Patent Application No. 2008-195660, filed on Jul. 30, 2008, the disclosure of which is incorporated herein by reference in its entirety.

### REFERENCE NUMERALS LIST

1 First dielectric layer
2 Second dielectric layer
3 Third dielectric layer
4 Antenna conductor
5 Ground conductor
6 Pad conductor (first pad conductor)
7,7′ Connection conductor
8,8′ Non-conductive section
9 Pad conductor (second pad conductor)
10A, 10B, 10C, 10D, 10E Planar antenna

1. A planar antenna comprising:
a first dielectric layer and a second dielectric layer; and
an antenna conductor, a ground conductor and a pad conductor, which are provided so as to sandwich the first dielectric layer and the second dielectric layer in the lamination direction respectively,
wherein the first dielectric layer is arranged between the antenna conductor and the ground conductor,
the second dielectric layer is arranged between either the antenna conductor or the ground conductor, and the pad conductor, and
a connection conductor that electrically connects either the antenna conductor or the ground conductor, whichever remains, and the pad conductor is provided.

2. The planar antenna according to claim 1, wherein the antenna conductor comprises a non-conductive section, and
the connection conductor penetrates the antenna conductor in the lamination direction via the non-conductive section and electrically connects the ground conductor and the pad conductor.

3. The planar antenna according to claim 1, wherein the ground conductor comprises a non-conductive section, and
the connection conductor penetrates the ground conductor in the lamination direction via the non-conductive section and electrically connects the antenna conductor and the pad conductor.

4. The planar antenna according to claim 1, further comprising a plurality of the pad conductors,
wherein the connection conductors are electrically connected to the plurality of pad conductors respectively.

5. The planar antenna according to claim 1, wherein the pad conductor is provided at a position where the voltage between the antenna conductor and the ground conductor becomes maximum at the resonance frequency of the antenna.

6. The planar antenna according to claim 5, wherein the pad conductors are provided in regions at both ends in which the separation distance between them is maximum in the region where the antenna conductor is formed, facing the pad conductors across the first or second dielectric layer.

7. The planar antenna according to claim 6, further comprising another pad conductor in a center region between both ends in which the separation distance between them is maximum.

8. A planar antenna comprising:
a first dielectric layer, a second dielectric layer and a third dielectric layer; and
an antenna conductor, a ground conductor, a first pad conductor and a second pad conductor provided so as to sandwich the first dielectric layer, second dielectric layer and third dielectric layer in the lamination direction respectively,
wherein the first dielectric layer is arranged between the antenna conductor and the ground conductor,
the second dielectric layer is arranged between either the antenna conductor or the ground conductor, and the pad conductor,
the third dielectric layer is arranged between either the antenna conductor or the ground conductor, whichever remains, and
the pad conductor,
the planar antenna comprises:
a first connection conductor that electrically connects the remaining antenna conductor or the remaining ground conductor, and the first pad conductor; and
a second connection conductor that electrically connects either the antenna conductor or the ground conductor, which was selected as regards the second dielectric layer, and the second pad conductor.

9. The planar antenna according to claim 8, wherein the antenna conductor comprises a non-conductive section, and
the first and second connection conductors penetrate the antenna conductor in the lamination direction via the non-conductive section and electrically connect the ground conductor and the first and second pad conductors respectively.

10. The planar antenna according to claim 8, wherein the ground conductor comprises a non-conductive section,
the first and second connection conductors penetrate the ground conductor in the lamination direction via the non-conductive section and electrically connect the antenna conductor and the first and second pad conductors respectively.

11. The planar antenna according to claim 8, wherein the first and second pad conductors are provided at positions where the voltage between the antenna conductor and the ground conductor becomes maximum at the resonance frequency of the antenna.

12. The planar antenna according to claim 11, wherein the first and second pad conductors are provided in regions at both ends in which the separation distance between them is maximum in the region where the antenna conductor is formed, facing the first and second pad conductors across the first and second dielectric layer.

13. The planar antenna according to claim 12, further comprising a further pad conductor in a center region between both ends in which the separation distance between them is maximum.

14. The planar antenna according to claim 2, further comprising a plurality of the pad conductors,
wherein the connection conductors are electrically connected to the plurality of pad conductors respectively.

15. The planar antenna according to claim 3, further comprising a plurality of the pad conductors,
wherein the connection conductors are electrically connected to the plurality of pad conductors respectively.

16. The planar antenna according to claim 2, wherein the pad conductor is provided at a position where the voltage between the antenna conductor and the ground conductor becomes maximum at the resonance frequency of the antenna.

17. The planar antenna according to claim 3, wherein the pad conductor is provided at a position where the voltage between the antenna conductor and the ground conductor becomes maximum at the resonance frequency of the antenna.

18. The planar antenna according to claim 4, wherein the pad conductor is provided at a position where the voltage between the antenna conductor and the ground conductor becomes maximum at the resonance frequency of the antenna.

19. The planar antenna according to claim 2, wherein the first and second pad conductors are provided at positions where the voltage between the antenna conductor and the ground conductor becomes maximum at the resonance frequency of the antenna.

20. The planar antenna according to claim 3, wherein the first and second pad conductors are provided at positions where the voltage between the antenna conductor and the ground conductor becomes maximum at the resonance frequency of the antenna.
